(19) United States
(12) Patent Application Publication
(10) Pub. No.: US 2008/0277418 A1
(43) Pub. Date: Nov. 13, 2008

(54) Container and a Fitting for a Container

(76) Inventors: Rodney Alan Vockler, Victoria (AU); Mark Kerr, New South Wales (AU); Trevor Nulty, Victoria (AU)

Correspondence Address: GREENLEE WINNER AND SULLIVAN P C, 4875 PEARL EAST CIRCLE, SUITE 200, BOULDER, CO, 80301, US

(21) Appl. No.: 11/914,598

(22) PCT Filed: May 17, 2006
(86) PCT No.: PCT/AU06/00658

§ 371 Date: May 14, 2008

(30) Foreign Application Priority Data
May 17, 2005 (AU) 2005902517

(51) Int. Cl. B67D 1/16; B65D 25/40; A47G 19/14

(52) U.S. Cl. 222/111; 222/570; 222/109; 222/465.1

(57) ABSTRACT

A spout assembly (14) for a container, such as for paint, comprising an outer spout (68) formed by a wall (74) extending parallel to the outer rim (50) of the assembly and a narrower inner spout (70) formed in a web (80) that partially closes an opening (60) through the assembly into the container. The outer spout controls the flow of material from the container that may be on the web so that that material merges with flow of material through the inner spout as the container contents are poured. A channel (76) may be provided between the outer rim (50) and the wall (74) of the outer spout to catch material that may dribble over the wall.

### TECHNICAL FIELD

The present invention relates to containers having an open upper end of the container body through which the contents may be poured or otherwise accessed and/or to fittings for the open upper end of such containers. The containers and/or fittings have been developed particularly for coating formulations, but may be similarly applicable for other liquids.

### BACKGROUND ART

One of the problems associated with traditional metal containers for paint and other coating formulations is the difficulty of pouring the contents from them. The containers have no spout formation and the contents tend to dribble down the outside of the can as they are poured and to sit on the rim around the container opening at the upper end of the container. This can make sealing of the container lid difficult.

There have been proposals to provide spouts on containers for coating formulations. For example, in U.S. Pat. No. 6,530,500 a spout extends part way around the container opening to enhance the pouring ability of the container. However, the spout does not concentrate or focus the flow through the container opening to any greater extent than the container opening, and dribbling will still tend to occur.

Another spout proposal is provided in WO 02/085713, in which a narrow spout is formed in a web extending across part of the container opening. This does focus or concentrate the flow of the contents during pouring from the container. However, the web tends to act as a trap for some of the contents, which can then dribble over the container rim and down the outside of the container when the contents are next poured. This trapping can possibly occur when the contents are poured, but is particularly likely to occur during shaking of the container to homogenise the contents.

There is therefore a need for an improved spout formation for containers.

### SUMMARY OF THE INVENTION

According to the present invention, there is provided a spout assembly for a container, the assembly having an outer rim and comprising a web extending between spaced portions of the assembly, an inner spout formed in the web and having a pouring cusp adjacent the rim, and an outer spout formed by a shaped wall that projects above the level of the rim and extends around the web adjacent to the rim on opposite sides of the pouring cusp.

Further according to the invention there is provided a container comprising a container body that is open at its upper end and spout assembly as described in the immediately preceding paragraph at the upper end of the container body.

By the invention, the spout assembly has improved pouring characteristics relative to a single pouring spout. By providing the inner spout and the outer spout, the inner spout may be shaped to concentrate the flow of the container contents through the spout assembly as the container is tipped. This is particularly advantageous with a low flow of the liquid contents, when there may be a greater risk of the contents dribbling down the exterior of the container body, especially as the container is tilted back to an upright condition to stop pouring. On the other hand, the outer spout is provided to control flow of the liquid contents over the web in which the inner spout is formed, whereby liquid flow through the outer spout during pouring of the container contents merges with the flow through the inner spout. The liquid contents may flow over the web because the container is excessively tilted to pour the contents or because they have become trapped on the web, for example as a result of shaking the container. By causing the liquid flow through the outer spout to merge with the flow through the inner spout, the likelihood and/or amount of dribbling is reduced.

The wall of the outer spout may extend around the web immediately adjacent to the rim. However, in a preferred embodiment, the spout assembly has a reclamation channel between the wall of the outer spout and the rim, which is open to the interior of the container in use, for example around the ends of the shaped wall or over the web. The reclamation channel will tend to catch liquid flow that does dribble from either of the inner and outer spouts and might otherwise dribble down the exterior of the container in use. Liquid caught in the reclamation channel can flow back into the container or be readily brushed or wiped back into the container. The bottom of the reclamation channel may be horizontal when the container carrying the spout assembly is in its upright rest condition, but to enhance liquid flow back into the container it is advantageously inclined between the wall of the outer spout and the rim and could be inclined downwardly from adjacent the pouring cusp, for example at no more than about 10 degrees, more preferably no more than about 5 degrees.

Preferably, when the wall of the outer spout does not extend around the web at the rim, the wall projects above the rim at the pouring cusp to the extent that an imaginary straight line joining the top of the wall at the pouring cusp to the top of the rim is vertical when the spout assembly is tilted for pouring at an angle of no more than about 60°, more preferably no more than about 45°.

The wall of the outer spout may have straight wall portions on opposite sides of the pouring cusp, but preferably it is curved. More preferably, the wall of the outer spout extends substantially parallel to the rim of the spout assembly, and most preferably is arcuate.

While the pouring cusp of the inner spout and the wall of the outer spout are both adjacent to the rim, they could be spaced from each other and still cause flows through the two spouts to merge. Preferably the pouring cusp of the inner spout is at the wall of the outer spout, whereby the web is interrupted at the pouring cusp.

The web may be horizontal between the inner and outer spouts in the rest condition of a container carrying the spout assembly, but advantageously it is inclined downwardly away from the pouring cusp to enhance liquid flow off the web back into the container in use. Preferably the web is inclined downwardly from the pouring cusp at no more than about 10 degrees, more preferably no more than about 5 degrees.

The pouring cusp of the inner spout may be pointed, but is preferably rounded. The inner spout may be substantially U-shaped, but is preferably substantially V-shaped so as to permit increased liquid flow through the inner spout, with the portions of the inner spout on opposite sides of the preferred rounded pouring cusp diverging from each other.

In one embodiment, the inner spout may be defined simply as an opening or recess, for example as a substantially planar opening or recess, in the web, such as is illustrated in FIG. 5 of the aforementioned WO 02/085713. More preferably the inner spout has a shaped wall projecting upwardly from the web. Such a shaped wall of the inner spout may have the same or a different height as the wall of the outer spout, but it will be appreciated that if the wall of the outer spout merges with the inner spout at the pouring cusp the two walls of the inner and outer spouts may be indistinguishable from each other at the pouring cusp.

The spout assembly may be integrally formed with the container, but is preferably formed as a separate assembly that is engageable with the container upper end. Such engagement may be by adhesive or other form of bonding, by a screw-threaded arrangement, by snap engagement or by any other suitable means. Advantageously, the spout assembly is formed as an annular collar that is engageable with the container upper end.

A spout assembly which is engageable with the container upper end may be provided as a pouring accessory that is removed after use to permit the container to be sealed with a lid. However, in a preferred embodiment a lid is closable over the inner and outer spouts of the spout assembly to provide a spout and lid assembly. Such a lid may be engageable with the spout assembly or container upper end in any of a variety of ways to secure the lid, but is preferably screw-threadedly engageable, in which case the screwthread on the spout assembly or container is advantageously interrupted adjacent the pouring cusp to alleviate any risk of liquid contamination of the thread. Advantageously, a lid that is closable over the spout assembly is engageable with a securing formation, such as a screw thread, on an outer surface of the rim of the spout assembly.

Preferably, the aforementioned lid includes an inner skirt portion or spigot which forms a seal with the spout assembly and/or container upper end outwardly of the outer spout when the lid is fully engaged with the spout assembly and/or container. The inner skirt portion advantageously prevents liquid flow from the interior of the container outwardly of the wall of the outer spout when the lid is engaged. Preferably, the inner skirt portion of the lid is in face to face contact with the outer face of the wall of the outer spout in its engaged condition. The bottom edge of the inner skirt portion of the lid may engage the spout assembly to provide a seal therealong. For example, the bottom edge of the inner skirt portion of the lid may engage a corresponding groove in the spout assembly and/or may abut a corresponding surface portion of the spout assembly remote from the wall of the outer spout to provide the seal therealong.

Where the lid is rotatable on the spout assembly, the wall of the outer spout may act as a scraper, at least at its rearwardsmost ends relative to the pouring direction, to clean liquid from the container off the inner surface of the inner skirt portion of the preferred lid. This can alleviate inadvertent transfer of the liquid on the lid when the lid is removed from the spout assembly.

The preferred lid that is closable over the spout assembly may also make sealing engagement with the spout assembly and/or container at a location distally of the lid engaging means on the spout assembly or container when fully secured thereto to seal the lid engaging means from the external atmosphere, so as to alleviate air-drying of any coating formulation or other liquid contents of the container on the lid engaging means.

Other preferred features of the lid that is closable over the spout assembly include one or more of the following: a mechanism, which may alternatively be on the spout assembly, that gives an audible signal to signify when the lid is fully closed; ribs, grooves or other formations to facilitate manual displacement of the lid relative to the spout assembly; and formations designed to facilitate stable stacking of the lidded containers by engaging the base of a container stacked above.

The spout assembly advantageously includes one or both of a brush-wiping edge and a handle. The brush-wiping edge may be on the opposite side of the opening into the container to the inner and outer spouts. The handle may be flexible for manual movement from a rest position to a carrying position above the spout assembly and optional lid, but is preferably pivoted on the spout assembly. Such a pivotable handle may be able to be supported or held in its rest position for storage and transporting, and conveniently is able to be pivoted through at least substantially 180 degrees of movement from the rest position.

Preferably the spout assembly and optional lid are moulded in a suitable plastics material, such as polyethylene, polypropylene, ABS or PET. The container may also be moulded in one of these plastics material, particularly if the spout assembly is integral with it. Alternatively, a separate spout assembly may be engageable with a metallic or other container. Advantageously, a separate spout assembly and optional lid at least substantially do not project outwardly of the cross-sectional profile of the container.

### BRIEF DESCRIPTION OF THE DRAWINGS

One embodiment of a spout assembly in accordance with the present invention will now be described by way of example only with reference to the accompanying drawings in which:

FIG. 1 is an exploded perspective view of a container including a spout and lid assembly in accordance with the invention;

FIG. 2 is a perspective view from above of the spout assembly with a handle raised;

FIG. 3 is a plain view from above of the spout assembly, with a handle in a rest position;

FIG. 4 is a rear elevational view of the spout assembly, with a handle raised;

FIG. 5 is an exploded sectional view of the spout assembly, lid and handle showing the rear half of the spout assembly; and

FIG. 6 is an elevational, part-sectional view of the spout, lid and handle assembly of FIG. 5 engaged with the container.

### DETAILED DESCRIPTION OF THE DRAWINGS

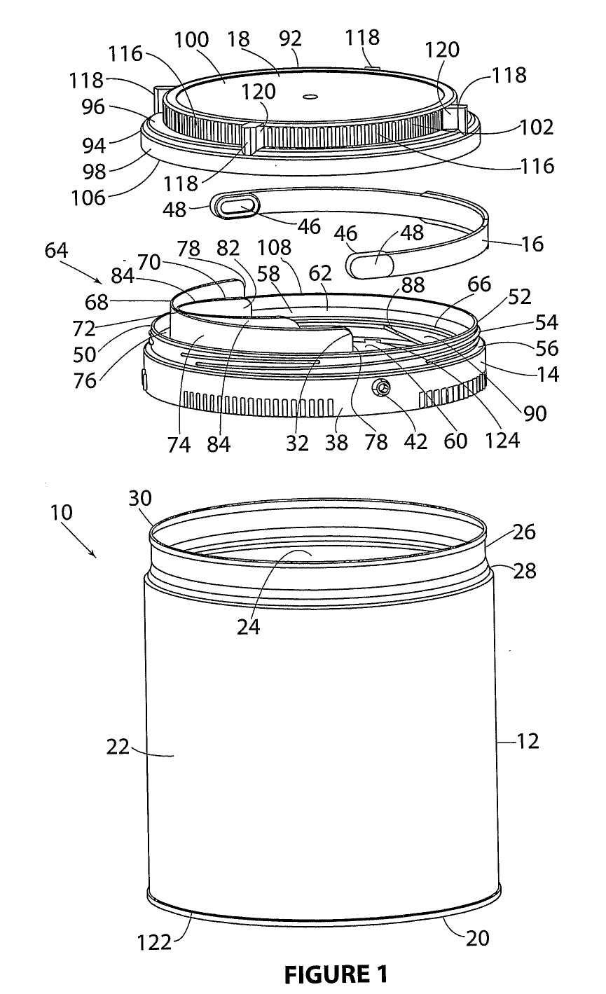

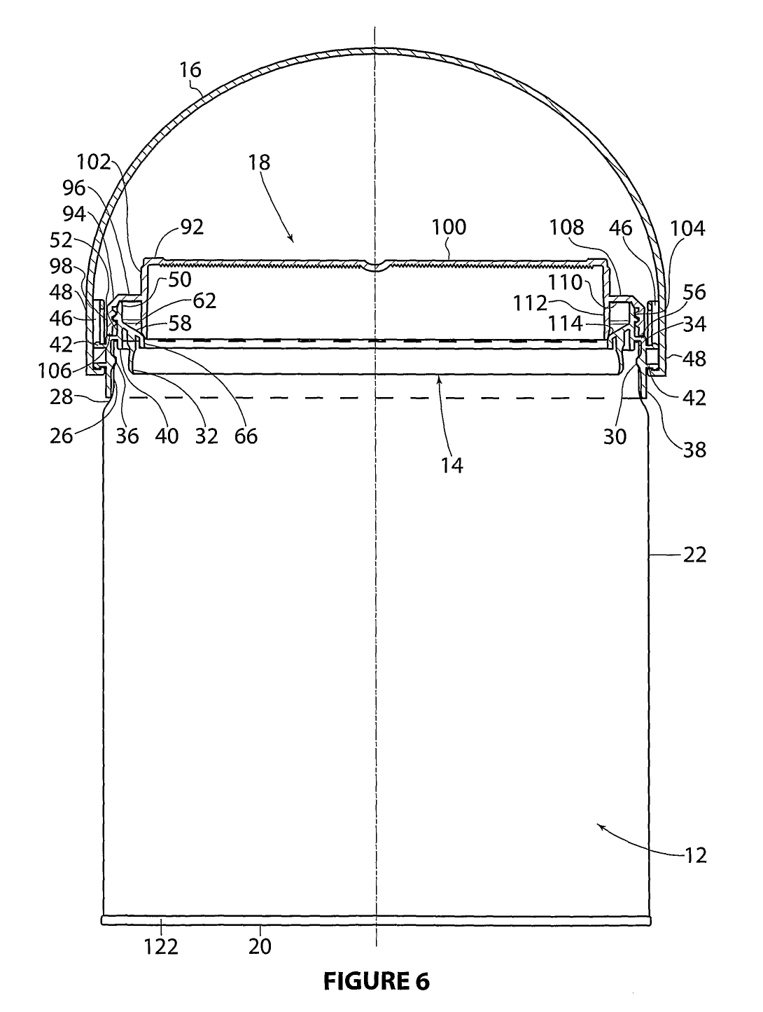

The container assembly 10 shown in FIGS. 1 and 6 comprises a metal can 12, an annular spout assembly 14, a handle 16 and a lid 18.

The metal can 12 may be conveniently formed of tin-plated steel and has a circular base 20 and an upright wall 22 leading to an open upper end 24. The particular shape of the metal can at its upper end 24 is not important to the invention, but as shown it is necked-in at a wall portion 26 to define a shoulder 28 between the wall portion 26 and the remainder of the upright wall 22. This is advantageous in that it permits the spout assembly 14 to not project substantially beyond the profile of the metal can when the two are engaged. As may be seen in FIG. 6, essentially only the handle 16 projects beyond the profile of the can 12.

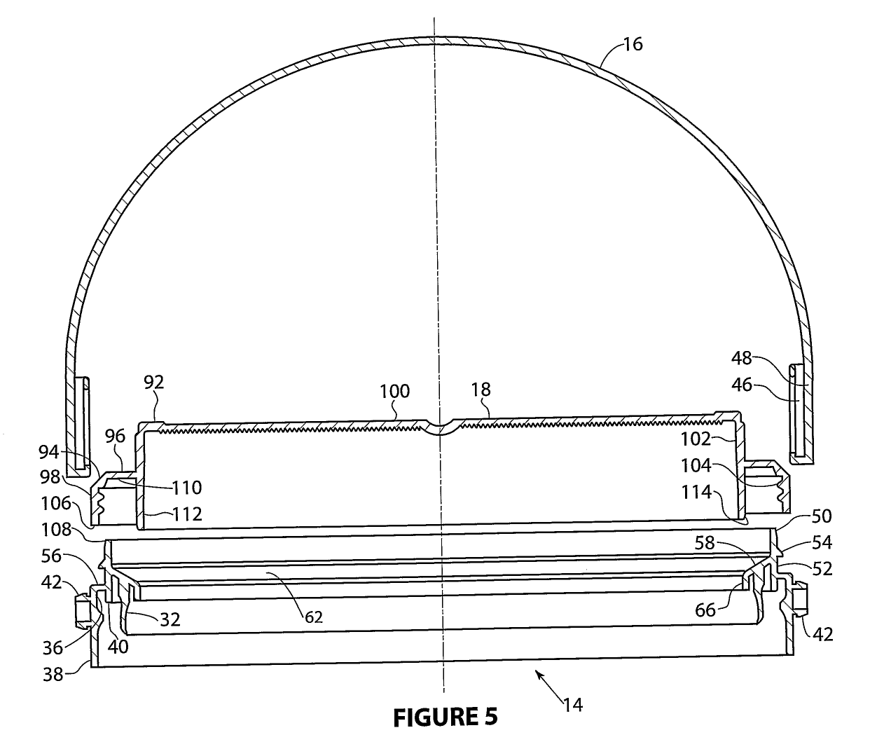

The open upper end 24 of the metal can has an enlarged rim 30 with which an annular inner skirt portion 32 of the spout assembly 14 is snap-engaged to secure the spout assembly on the metal can (FIG. 6). The particular manner in which the spout assembly engages the metal can does not form part of the invention since a wide variety of different methods may be adopted, as will be clear to those skilled in the art. As illustrated in FIG. 6, an upstanding wall portion 34 of the metal can wall 22 projects above the enlarged rim formation 30 and is received in a corresponding groove 36 (see also FIG. 5) in the spout assembly. The groove 36 is defined between an outer skirt 38 of the spout assembly and a depending annular flange 40. When the spout assembly 14 is properly engaged with the metal can 12, the depending flange 40 engages the enlarged rim 30 to provide an additional seal between the can and spout assembly. At the same time, the outer skirt 38 of the spout assembly closely overlies the wall portion 26 and is seated on the shoulder 28.

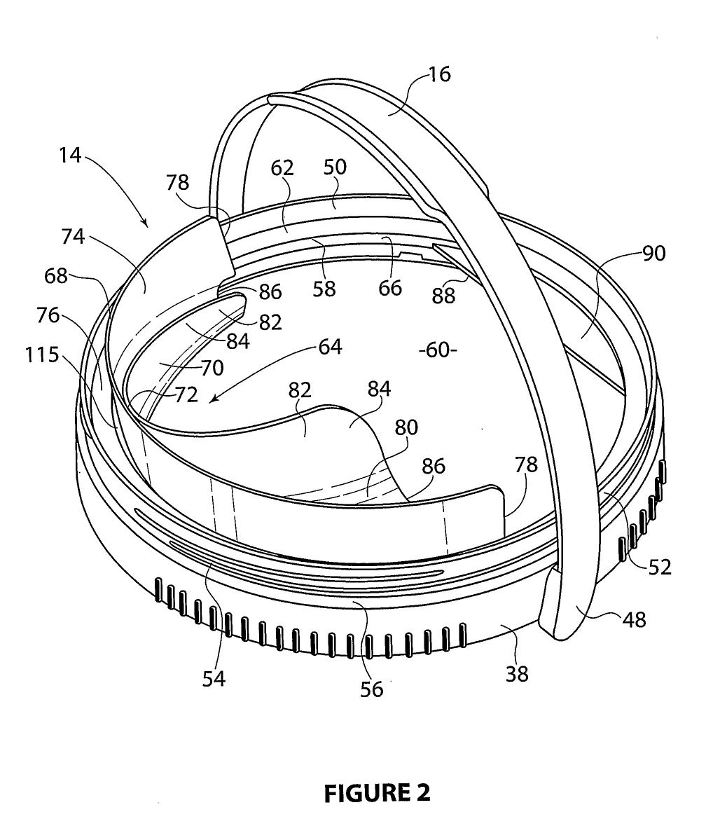

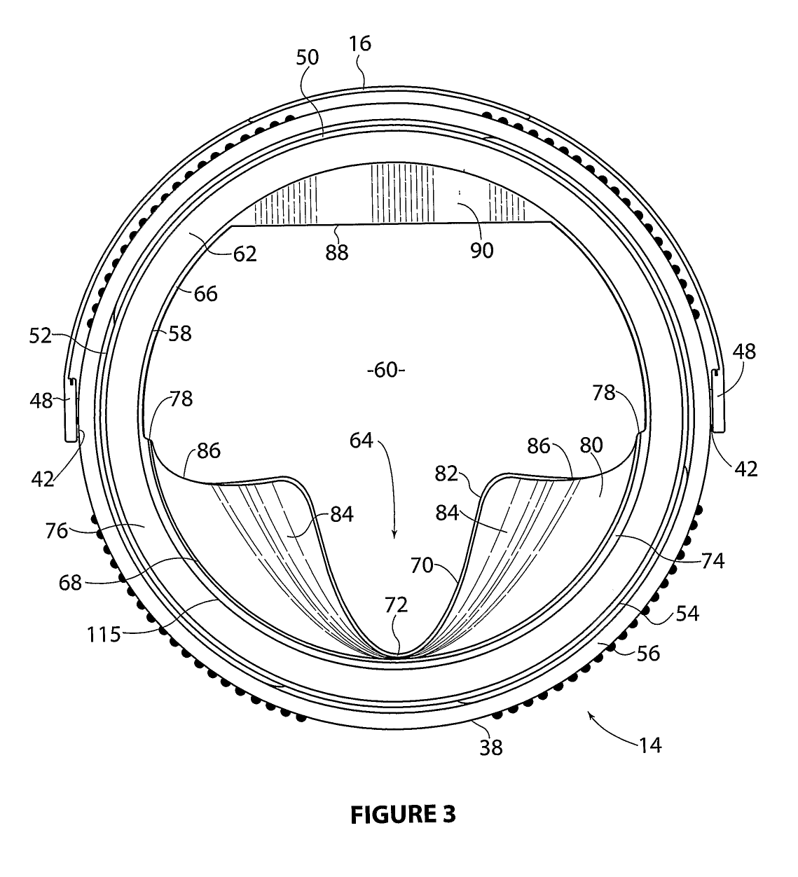

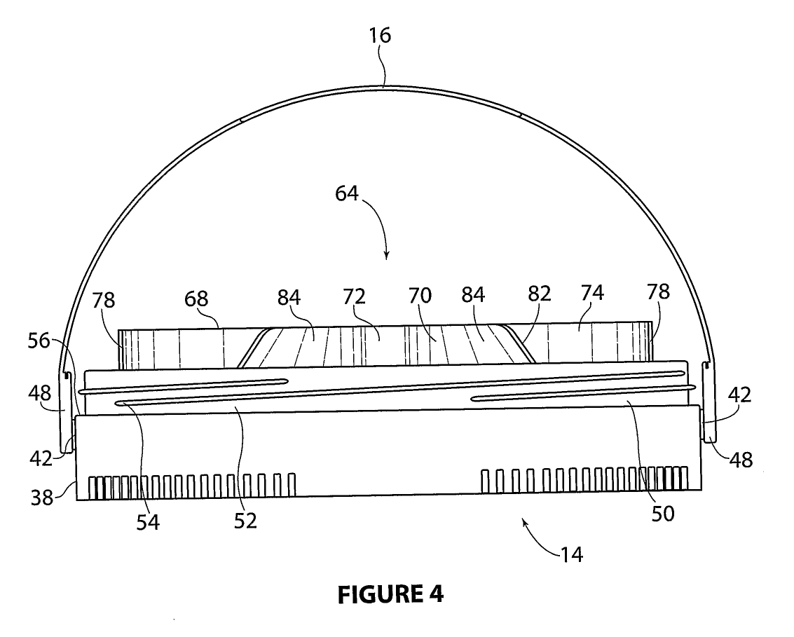

The spout assembly 14 is injection moulded, preferably in polypropylene, and is in the form of a collar that engages the metal can 12 as described. Externally, the outer skirt 38 of the spout assembly 14 has opposed lugs 42 for pivotally engaging the handle 16. The cross-section of FIG. 5 is taken through the lugs 42. The handle 16 is also injection moulded in polypropylene, and is self-supporting but flexible. It has opposed recesses 46 at its ends 48 for engaging the spout assembly 14 by snap-engagement over the respective lugs 42. The recesses 46 are shown elongated to permit the handle 16 to lie substantially flush with the outer skirt 38 of the spout assembly when in the rest position substantially perpendicular to the axis of the container (see FIG. 3), and then to be pulled out by a user in order to accommodate the user's fingers to pivot the handle in to an upright carrying position as shown in FIGS. 2 and 4 as well as 6. However in a currently preferred embodiment the recesses 46 are circular to provide for simple pivoting of the handle.

The handle 16 is preferably supported in the substantially perpendicular or horizontal rest position shown in FIG. 3. This may be, for example, by a degree of stiffness in the pivot 42, 46 or by a nib (not shown) on the outer skirt 38 of the spout assembly 14 which engages a portion of the handle remote from the ends 48. However, in a currently preferred embodiment a respective nib (not shown) is provided adjacent each of the opposed lugs 42 on the outer skirt 38 to support the handle at each end 48 in its rest position.

Projecting upwardly above the outer skirt 38 is a rim 50 of the spout assembly 14. The rim 50 is in the form of an outer wall, on the outer surface 52 of which is formed a multi-start screwthread 54 for engagement by the lid 18. The rim 50 is inset slightly from the outer skirt 38 to define an outer shoulder 56 therebetween.

Inside the rim 50, and at least partly below the outer wall that defines it, an annular flange 58 extends around the collar to essentially define an opening 60 through the spout assembly into the metal can 12. The upper surface 62 of the flange 58 is inclined downwardly towards the opening 60 to permit liquid on it from the metal can 12 to run off. A spout arrangement 64 extends from a radially inner edge 66 of the flange 58.

The spout arrangement 64 comprises an outer spout 68 and an inner spout 70 which merge at a pouring cusp 72 adjacent the rim 50.

The outer spout 68 comprises an arcuate upright wall 74 extending around substantially one half of the inner circumference of the flange 58 parallel to the rim 50. The upright wall 74 projects above the rim 50 and is spaced from the outer wall defining the rim 50 to form a reclamation channel 76 therebetween, the floor of which is the upper surface 62 of the flange 58. The reclamation channel 76 permits liquid contents that may flow over the spout arrangement 64 in to the channel to flow back into the metal can 12 around the ends 78 of the upright wall 74 of the outer spout. If the liquid contents of the container assembly 10 are too viscous to flow along the reclamation channel 76, they may be readily brushed or wiped there along the channel.

The upright wall 74 projects above the rim 50 to the extent that an imaginary line drawn between the top of the upright wall 74 and the top of the rim 50 at the pouring cusp 72 extends at an angle of about 60° when the spout assembly 14 is horizontal, for example when the metal can 12 on which the spout assembly 14 is engaged is in its upright rest position. This means that the top of the wall 74 is at a predetermined minimum height above the rim 50 relative to the spacing of the wall and rim so as to alleviate the likelihood of the container contents catching the rim 50 as they are poured from the container assembly 10.

The inner spout 70 is formed in a web 80 that extends across the annular flange 58 from substantially between the ends 78 of the upright wall 74 of the outer spout to partially close the opening 60 into the metal can 12. The inner spout 70 is defined by an upright wall 82 which flares upwardly from the web to the height of the upright wall 74 of the outer spout. The wall 82 is shaped so as to be rounded at the pouring cusp 72 with wall portions 84 that diverge from each other away from the pouring cusp so that the inner spout is essentially V-shaped with a rounded base. The wall portions 84 are upwardly inclined towards each other along their rearwardsmost extent (relative to the pouring direction) so as to deflect liquid contents of the metal can towards the pouring cusp 72 as they are poured.

As the inner spout 70 merges with the wall 74 of the outer spout 68 at the pouring cusp 72, the inner spout effectively interrupts the web 80. The portions of the web 80 on each side of the inner spout 70 taper from the rearwardsmost edge 86 towards the pouring cusp 72, between the wall portions 84 of the inner spout and the upright wall 74 of the outer spout, so as to guide any liquid contents of the container assembly 10 on the web 80 towards the pouring cusp 72 to merge with the flow through the inner spout 70. Such liquid contents may be on the web 80 as a result of the pouring or, more likely, as a result of stirring or shaking the contents of the container assembly. After pouring, any residual liquid contents on the web 80 may be brushed or wiped back into the metal can 12. The web 80 as shown is substantially horizontal, but inclining the web portions slightly downwardly away from the pouring cusp may assist this.

The spout arrangement 64 is designed to minimise dripping of the liquid contents as they are poured to alleviate contamination of the outer surfaces of the rim 50, outer skirt 38 and can wall 22. However, there may still be a few circumstances where such dripping does occur, and the screwthread 54 for the lid 18 on the outer surface 52 of the rim 50 is interrupted beneath the pouring cusp 72 to alleviate blocking or locking of the screwthread by the liquid contents setting there.

A brush wiping edge 88 is formed on a web 90 extending across the inner edge 66 of the flange 58 opposite the spout arrangement 64.

The lid 18 is injection moulded preferably in high density polyethylene and is provided with a cap portion 92 and a skirt portion 94 (seen most clearly in FIG. 5, but also in FIGS. 1 and 6). The skirt portion comprises a flange 96 and a depending outer skirt 98. The cap portion 92 comprises a top 100 and a wall 102 from which the flange 96 projects outwardly.

The outer skirt 98 has an internal screwthread 104 to mate with the screwthread 54 on the outer surface 52 of the spout assembly rim 50. When the screwthreads are fully engaged, the bottom edge 106 of the outer skirt 98 abuts the outer shoulder 56 of the spout assembly, and a seal, such as a tongue and groove arrangement, (not shown) may be provided between the two to minimise the passage of air from the atmosphere into the interior of the container assembly 10. At the same time, the upper edge 108 of the spout assembly rim 50 engages the underside 110 of the skirt portion 94 to enhance the seal (see FIG. 6). Means (not shown) may be provided between the lid 18 and spout assembly 14 to provide an audible signal when the screwthreads 54 and 104 are fully engaged. Such means may be a plastic flap that clicks as the lid 18 approaches full screwthreaded engagement on, for example, one of the skirt portion 94 and spout assembly rim 50 or shoulder 56.

The wall 102 of the cap portion 94 projects downwardly beyond the flange 96 of the skirt portion 94 to form an inner skirt or spigot 112. The downwards extent of the skirt 112 is substantially the same as the outer skirt 98 of the skirt portion 94, and when the lid 18 is fully engaged on the spout assembly 14 the bottom outer edge portion 114 of the skirt forms an abutting seal against the inner edge 66 of the flange 58 of the spout assembly. In the reclamation channel 76 (not shown in FIGS. 5 and 6), between the rim 50 and the upright wall 74 of the outer spout 68, the bottom outer edge portion 114 of the skirt 112 engages a shallow groove 115 formed between the wall 74 and the upper surface 62 of the flange to provide the seal along the reclamation channel.

The skirt 112 extends immediately adjacent the upright wall 74 as the lid 18 is engaged with and disengaged from the spout assembly 14, and at least the ends 78 of the wall 74 act as a scraper against the inner surface of the skirt 112 and wall 102 to remove liquid contents from the inner surface as the lid is rotated relative to the spout assembly.

Externally (see FIG. 1), the lid 18 has an array 116 of vertical ribs on the outer surface of the wall 102 to enhance a consumer's grip on the lid as the lid is engaged with and disengaged from the spout assembly. Additionally, a series of four nibs 118 are located at right angles to each other and extend between the wall 102 and the flange 96 of the skirt portion 94. The nibs 118 are hollow with an open upper end and are designed to assist opening the lid by means of an appropriate tool (not shown) engaging either the outer surface 120 or the interior of one or more of the nibs. For example, a suitable key can be designed to engage the interior of two opposed nibs 118.

The radial extent of the nibs 118 is advantageously such that the nibs can be closely received within a dependent rim 122 at the base 20 of a metal can 12 above so as to enhance stable stacking of plural container assemblies 10.

Recesses 124 corresponding to the nibs 118 may also be formed in the bottom edge of the inner skirt 32 of the spout assembly 14, as shown in one case in FIG. 1. Engagement of the recesses 124 by the nibs 118 of an underlying lid 18 prevents relative rotation of plural stacked spout and lid assemblies.

The inner portions of the spout assembly 14 and lid 18 that may contact the liquid contents of the container assembly 10 in use may be coated or formed in a manner that alleviates skinning when the liquid contents comprise a coating formulation. The problem of skinning and some means of alleviating it are described in, for example, Australian Patents AU 756501 and AU 760094.

Those skilled in the art will appreciate that the invention described herein is susceptible to variations and modifications other than those specifically described. It is to be understood that the invention includes all such variations and modifications which fall within its spirit and scope. The invention also includes all the steps, features, compositions and compounds referred to or indicated in this specification, individually or collectively, and any and all combinations of any two or more of said steps or features.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A spout assembly for a container, the assembly having an outer rim and comprising a web extending between spaced portions of the assembly, an inner spout formed in the web and having a pouring cusp adjacent the rim, and an outer spout formed by a wall that projects above the level of the rim and extends around the web adjacent to the rim on opposite sides of the pouring cusp.

2. A spout assembly according to claim 1, wherein a reclamation channel extends between the wall of the outer spout and the rim.

3. A spout assembly according to claim 2, wherein the wall of the outer spout projects above the rim at the pouring cusp to the extent that an imaginary straight line joining the top of the shaped wall at the pouring cusp to the top of the rim is vertical when the spout assembly is tilted for pouring at an angle of no more than about 60°.

4. A spout assembly according to claim 1, wherein the wall of the outer spout extends substantially parallel to the outer rim.

5. A spout assembly according to claim 1, wherein the web is inclined downwardly away from the pouring cusp of the inner spout.

6. A spout assembly according to claim 1, wherein the pouring cusp of the inner spout is rounded.

7. A spout assembly according to claim 1, wherein the inner spout is substantially V-shaped.

8. A spout assembly according to claim 1, wherein the inner spout has a shaped wall projecting upwardly from the web.

9. A spout assembly according to claim 8, wherein the shaped wall of the inner spout has the same height at the pouring cusp as the wall of the outer spout.

10. A spout assembly according to claim 1, wherein the pouring cusp of the inner spout is at the wall of the outer spout.

11. A spout assembly according to claim 1, wherein the outer rim is annular.

12. A spout and lid assembly, comprising a spout assembly according to claim 1 and a lid that is closable over the spout assembly.

13. A spout and lid assembly according to claim 12, wherein the spout assembly comprises engaging means for securing the lid thereto, and wherein the lid sealingly engages the spout assembly distally of the lid engaging means on the spout assembly when full secured thereto to seal the lid engaging means from the external atmosphere.

14. A spout and lid assembly according to claim 12, wherein the lid is screw-threadedly engageable with a co-operating screw thread on the outer rim and the co-operating screw thread on the outer rim is interrupted adjacent the pouring cusp of the inner spout.

15. A spout and lid assembly according to claim 12, wherein the lid includes an inner skirt portion which forms a seal with the spout assembly outwardly of the outer spout when the lid is fully engaged with the spout assembly.

16. A spout and lid assembly according to claim 15, wherein the inner skirt portion of the lid is in face to face contact with the outer face of the wall of the outer spout in its engaged condition.

17. A spout and lid assembly according to claim 15, wherein a bottom edge of the inner skirt portion of the lid engages the spout assembly to provide a seal therealong.

18. A spout and lid assembly according to claim 12, which includes a mechanism that gives an audible signal as the lid is fully secured to the spout assembly.

19. A container comprising a container body that is open at its upper end and a spout assembly according to claim 1 or a spout and lid assembly according to claim 12 at the upper end of the container body.

20. A container according to claim 19, wherein the container body is metallic and the spout assembly is moulded in plastic material.
